(19) United States
(12) Patent Application Publication
(10) Pub. No.: US 2020/0057932 A1
(43) Pub. Date: Feb. 20, 2020

(54) SYSTEM AND METHOD FOR GENERATING TIME-SPECTRAL DIAGRAMS IN AN INTEGRATED CIRCUIT SOLUTION

(71) Applicant: GYRFALCON TECHNOLOGY INC., Milpitas, CA (US)

(72) Inventors: Xiang Gao, San Jose, CA (US); Lin Yang, Milpitas, CA (US)

(73) Assignee: GYRFALCON TECHNOLOGY INC., Milpitas, CA (US)

(21) Appl. No.: 15/998,632

(22) Filed: Aug. 16, 2018

(51) Int. Cl. G06N 3/04; G06N 3/08; G10L 25/30

(52) U.S. Cl. CPC G06N 3/04; G10L 25/30; G06N 3/08

(57) ABSTRACT

A system for encoding data in an artificial intelligence (AI) integrated circuit solution may include a processor configured to receive voice data comprising at least a segment of an audio waveform, load the voice data into an input array of a cellular neural network (CeNN) in the AI integrated circuit, load one or more wavelet filters into one or more kernels of the CeNN, and perform one or more operations on the voice data to generate a time-spectral diagram. The time-spectral diagram may include a wavelet transformation of the voice data. Each of the one or more filters respectively represents a frequency. The system may also output a voice recognition result based on the time-spectral. Sample training data may be encoded in a similar manner for training the cellular neural network.

### BACKGROUND

This patent document relates generally to encoding data into an artificial intelligence integrated circuit. For example, system and method for generating time-spectral diagrams in an audio recognition integrated circuit solution are described.

In an artificial intelligence solution, such as recurrent neural network (RNN) or convolutional neural network (CNN), audio recognition tasks typically require preprocessing raw audio data in the time domain to generate spectral information, such as spectrogram or Mel-frequency cepstral coefficients (MFCC) before training and recognition tasks are performed. This preprocessing tasks may impose challenges, particular on an embedded device with limited computing powers as such preprocessing tasks are usually computation extensive which may drain significant resources from the device. For example, for an input image with size of 224×224 and one channel, 224 Fast Fourier Transforms (FFT)s (1024 or 512 point) are required. On an Android system, this may take the microcontroller 370 ms to compute. For a typical PC with an i-7 processor, it may take 15 ms to compute the 224×224 spectrogram for one channel. Whether these preprocessing tasks are performed on an embedded device or a desktop computer, significant computing powers may be needed.

Additionally, AI integrated circuit solutions may also face challenges in arranging data to be loaded into the AI chip having physical constraints. Only meaningful models can be obtained through the training if data are arranged (encoded) properly inside the chip. For example, if intrinsic relationships exist among events that occur proximately in time (e.g., waveform segments in a syllable or in a phrase in a speech), then the intrinsic relationships may be discovered by the training process when the data that are captured proximately in time are arranged to be loaded to the AI chip and processed by the AI chip concurrently.

### BRIEF DESCRIPTION OF THE DRAWINGS

The present solution will be described with reference to the following figures, in which like numerals represent like items throughout the figures.

FIG. 1 illustrates an example system in accordance with various examples described herein.

FIG. 2 illustrates a diagram of an example of a process for implementing a voice recognition task in an AI chip in accordance with some examples described herein.

FIG. 3 illustrates an example of a process of using multiple filters in generating a time-spectral diagram in accordance with various examples described herein.

FIGS. 4A & 4B illustrate an example of data encoding and kernel pattern for implementing an audio recognition task in an AI chip in accordance with some examples described herein.

FIG. 5 illustrates an example of a process for generating a time-spectral diagram using two layers in a network in accordance with some examples described herein.

FIG. 6 illustrates an example of kernel pattern and data alignment for implementing a convolution in audio recognition task in an AI chip in accordance with some examples described herein.

FIGS. 7A & 7B illustrate an example of data encoding and kernel pattern for implementing an audio recognition task in an AI chip in accordance with some examples described herein.

FIG. 8 illustrates an example of a process for generating a time-spectral diagram in accordance with some examples described herein.

FIGS. 9A & 9B illustrate an example of data encoding and kernel pattern for implementing an audio recognition task in an AI chip in accordance with some examples described herein.

FIG. 10 illustrates an example of a process for generating a time-spectral diagram in accordance with some examples described herein.

FIG. 11 illustrates an example of data encoding for implementing an audio recognition task in an AI chip in accordance with some examples described herein.

FIG. 12 illustrates various embodiments of one or more electronic devices for implementing the various methods and processes described herein.

### DETAILED DESCRIPTION

As used in this document, the singular forms “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.” Unless defined otherwise, all technical and scientific terms used in this document have the same meanings as commonly understood by one of ordinary skill in the art.

Each of the terms “artificial intelligence logic circuit” and “AI logic circuit” may include an example of a logic circuit that is configured to execute certain AI functions such as a neural network in AI or machine learning tasks. An AI logic circuit may be a processor. An AI logic circuit may also be a logic circuit that is controlled by an external processor and executes certain AI functions.

Each of the terms “integrated circuit,” “semiconductor chip,” “chip” and “semiconductor device” may include an example of an integrated circuit (IC) that contains electronic circuits on semiconductor materials, such as silicon, for performing certain functions. For example, an integrated circuit may include a microprocessor, a memory, a programmable array logic (PAL) device, an application-specific integrated circuit (ASIC) or others. An integrated circuit that contains an AI logic circuit is referred to as an AI integrated circuit or an AI chip.

The term “AI chip” may include a hardware- or software-based device that is capable of performing functions of an AI logic circuit. An AI chip may be a physical AI integrated circuit or a virtual chip, i.e., software-based. For example, a virtual AI chip may include one or more process simulators to simulate the operations of a physical AI integrated circuit.

The term of “AI model” may include data that include one or more weights that are used for, when loaded inside an AI chip, executing the AI chip. For example, an AI model for a given CNN may include the weights for one or more convolutional layers of the CNN.

Each of the terms “data precision,” “precision” and “numerical precision” as used in representing values in a digital representation in a memory refers to the maximum number of values that the digital representation can represent. If two data values are represented in the same digital representation, for example, as an unsigned integer, a data value represented by more bits in the memory generally has a higher precision than a data value represented by fewer bits. For example, a data value using 5 bits has a lower precision than a data value using 8 bits.

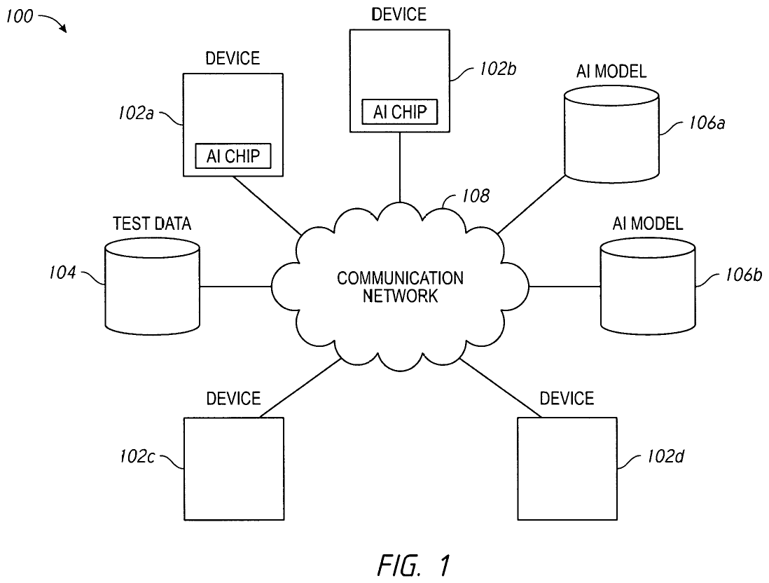

With reference to FIG. 1, a system 100 includes one or more processing devices 102a-102d for performing one or more functions in an artificial intelligence task. For example, some devices 102a, 102b may each have one or more AI chips. The AI chip may be a physical AI integrated circuit. The AI chip may also be software-based, i.e., a virtual AI chip that includes one or more process simulators to simulate the operations of a physical AI integrated circuit. A processing device may be coupled to an AI integrated circuit and contain programming instructions that will cause the AI integrated circuit to be executed on the processing device. Alternatively, and/or additionally, the a processing device may also have a virtual AI chip installed and the processing device may contain programming instructions configured to control the virtual AI chip so that the virtual AT chip may perform certain AI functions.

System 100 may further include a communication network 108 that is in communication with the processing devices 102a-102d. Each processing device 102a-102d in system 100 may be in electrical communication with other processing devices via the communication network 108. Communication network 108 may include any suitable communication links, such as wired (e.g., serial, parallel, optical, or Ethernet connections) or wireless (e.g., Wi-Fi, Bluetooth, mesh network connections) or any suitable communication network later developed. In some scenarios, the processing devices 102a-102d may communicate with each other via a peer-to-peer (P2P) network or a client/server based communication protocol. System 100 may also include one or more AI models 106a-106b. System 100 may also include one or more databases that contain test data for training the one or more AI models 106a-106b.

In some scenarios, the AI chip may contain an AI model for performing certain AI tasks. For example, an AI model may be a CNN that is trained to perform voice or image recognition tasks. A CNN may include multiple convolutional layers, each of which may include multiple weights. In the case of physical AI chip, the AI chip may include an embedded cellular neural network that has a memory for containing the multiple weights in the CNN. In some scenarios, the memory in a physical AI chip may be a one-time-programmable (OTP) memory that allows a user to load a CNN model into the physical AI chip once. Alternatively, a physical AI chip may have a random access memory (RAM) or other types of memory that allows a user to load and/or update a CNN model in the physical AI chip.

In the case of virtual AI chip, the AI chip may include a data structure to simulate the cellular neural network in a physical AI chip. A virtual AI chip can be of particular advantageous when multiple tests need to be run over various CNNs in order to determine a model that produces the best performance (e.g., highest recognition rate or lowest error rate). In each test run, the weights in the CNN can vary and, each time the CNN is updated, the weights in the CNN can be loaded into the virtual AI chip without the cost associated with a physical AI chip. After the CNN model is determined, the final CNN model may be loaded into a physical AI chip for real-time applications.

Each of the processing devices 102a-102d may be any suitable device for performing an AI task (e.g., voice recognition, image recognition, scene recognition etc.), training an AI model 106a-106b or capturing test data 104. For example, the processing device may be a desktop computer, an electronic mobile device, a tablet PC, a server or a virtual machine on the cloud. Various methods may be implemented in the above described embodiments in FIG. 1 to accomplish various data encoding methods, as described in detail below.

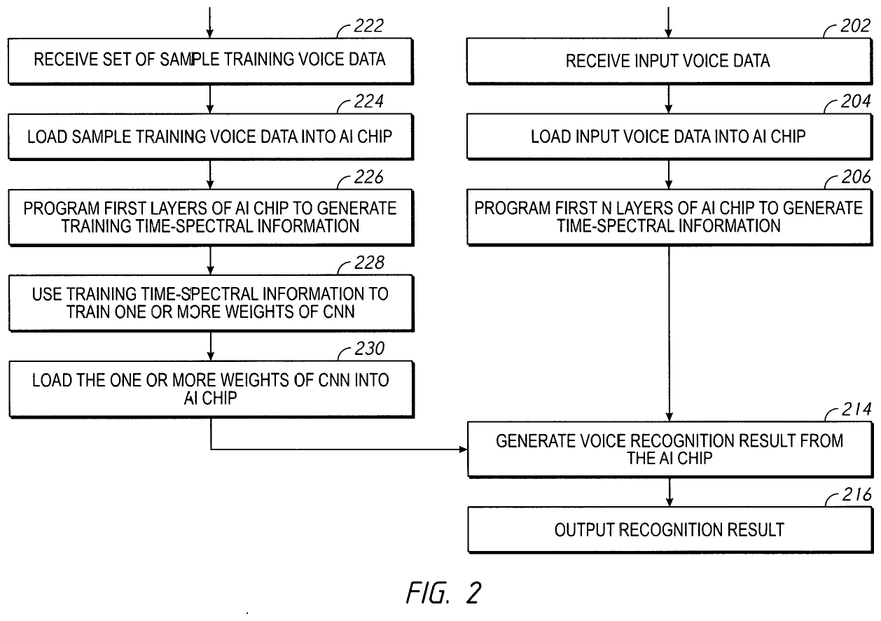

With reference to FIG. 2, a diagram of an example of a process for implementing a voice recognition task in an AI chip in accordance with some examples described herein. In some scenarios, an AI integrated circuit may have an embedded CeNN which may include a number of channels for implementing various AI tasks. In some scenarios, an encoding method may include receiving input voice data at 202. The input voice data may include one or more segments of an audio waveform. A segment of an audio waveform may include an audio waveform of voice or speech, for example, a syllable, a word, a phrase, a spoken sentence, and/or a speech dialog of any length. Receiving the input voice data may include: receiving a segment of waveform of voice signals directly from an audio capturing device, such as a microphone; and converting the waveform to a digital form. Receiving input voice data may also include retrieving voice data from a memory. For example, the memory may contain voice data captured by an audio capturing device. The memory may also contain video data captured by a video capturing device, such as a video camera. The method may retrieve the video data and extract the audio data from the video data.

The encoding method may also include loading the input voice data into an AI chip at 204. In loading the input voice data into the AI chip at 204, the input voice data may be loaded into one or more channels in a cellular neural network (CeNN) in the AI chip, examples of various arrangement of voice data will be described further in detail. In some examples, the AI chip may contain an AI model, e.g., a CNN, which may have multiple layers, each having a filter/kernel. For example, a filter/kernel may be a 3 by 3 array, and the AI chip may be programmed to perform a convolution by applying a filter/kernel to each respective layer in the CNN. In some examples, the encoding method may include programming the first N layers of the AI chip to generate time-spectral information at 206. For example, programming may include feeding programming instructions to the AI chip to cause a microprocessor of the AI chip to operate. Programming may also include sending command instructions to the AI chip from a controller (e.g., an external device, such as a mobile or desktop device) to cause the AI chip to operate. In some examples, raw voice data may be received at a first layer of the CNN and propagated through one or more layers (e.g., N layers) of the CNN to generate the time-spectral information. A time-spectral diagram includes a plurality of pixels each comprising a value that represents an audio intensity of the segment of the audio waveform at a time in the segment and a frequency. The number N may be any suitable number. This step eliminates the need to preprocess audio data to generate a time-spectral diagram, e.g., a spectrogram, before being loaded into an AI chip, thus faster computation utilizing the hardware of the AI chip will be achieved.

With further reference to FIG. 2, the method may include generating recognition results for the input voice data at 214, the method may further include: executing, by the AI chip, one or more programming instructions to perform operations on the first N layers of the AI chip to generate the time-spectral information. The method at 214 may further include using subsequent M layers of the AI chip to perform audio recognition task based on the time-spectral information generated from the first N layers in the AI chip. The numbers N and M may be any suitable numbers for performing time-spectral generation and voice recognition tasks. For example, an AI chip may have a CeNN, which has multiple layers. The first two layers may be used to generate time-spectral information from raw voice signals and the remaining layers may be used to perform recognition tasks based on the results from the first two layers.

The method may further include outputting the voice recognition result at 216. Outputting the voice recognition result 216 may include storing a digital representation of the recognition result to a memory device inside the AI chip or outside the AI chip, the content of the memory can be retrieved by the application running the AI task, an external device or a process. The application running the AI task may be an application running inside the AI integrated circuit should the AI integrated circuit also have a processor. The application may also run on a processor on the communication network (102c-102d in FIG. 1) external to an AI chip, such as a computing device or a server on the cloud, which may be electrically coupled to or may communicate remotely with the AI chip. Alternatively, and/or additionally, the AI chip may transmit the recognition result to a processor running the AI application or a display.

In a non-limiting example, the embedded CeNN in the AI chip may be configured to have a maximal number of channels, e.g., 3, 8, 16, 128 or other numbers, and each channel may be configured to include a 2D array having a size, e.g., 224 by 224 pixels, and each pixel value may have a depth, such as, for example, 5 bits. Input data for any AI tasks using the AI chip must be encoded to adapt to such hardware constraints of the AI chip. For example, loading the input voice data into the AI chip at 204 may including arranging voice data in one-dimension (1D) into rows and columns in two-dimension (2D) in column-wise or row-wise. Assuming the 2D array in each channel of CeNN includes 224×224 pixels, the method may fill the first column of the input array of the CeNN by the first 224 data points in the voice input data, followed by the second column that takes from the next 224 data points in the voice input data. In a non-limiting example, each CeNN layer may have a number of channels, and the voice input data may also be filled into each layer in channel-wise, followed by column-wise or row-wise fashion. The above described 2D array sizes, channel number and depth for each channel are illustrative only. Other sizes may be possible. Further, the number of 2D arrays for encoding into the CeNN in the AI chip may be smaller than the maximum channels of the CeNN in the AI chip.

In some scenarios, the embedded CeNN in the AI chip may store a CNN that was trained and pre-loaded. The structure of the CNN may correspond to the same constraints of an AI integrated circuit. For example, for the above illustrated example of the embedded CeNN, the CNN may correspondingly be structured to have three channels, each having an array of 224×224 pixels, and each pixel may have a 5-bit value. The training of the CNN may include encoding the training data and programming the AI chip in the same manner as described in the recognition process (e.g., block 204, 206), and an example of a training process is further explained, as below.

With continued reference to FIG. 2, in some scenarios, a training method may include: receiving a set of sample training voice data at 222, which may include one or more segments of an audio waveform and loading the set of sample training voice data into the AI chip at 224. Receiving the set of sample training voice data 222 may be done in a similar fashion as receiving input voice data 202. For example, receiving the sample training voice data may include: receiving a segment of waveform of training voice signals directly from an audio capturing device, such as a microphone; and converting the waveform to a digital form. Receiving the sample training voice data may also include retrieving training voice data from a memory. For example, the memory may contain training voice data captured by an audio capturing device. The memory may also contain training video data captured by a video capturing device, such as a video camera. The method may retrieve the training video data and extract the audio data from the training video data.

In some examples, the sample training voice data may be loaded into the AI chip in a similar manner as in block 204. For example, loading the sample training voice data into the AI chip at 224 may including arranging the sample training voice data in one-dimension (1D) into rows and columns in two-dimension (2D) in a column-wise or row-wise, or in a channel-wise fashion followed by column- or row-wise fashion. Assuming the 2D array in each channel of CeNN includes 224×224 pixels, the method may fill the first column of the input array of the CeNN by the first 224 data points in the sample training input data, followed by the second column that takes from the next 224 data points in the sample training voice data. In a non-limiting example, each CeNN layer may have a number of channels, and the sample training input data may also be filled into each layer in a channel-wise fashion, followed by column-wise or row-wise fashion. The above described 2D array sizes, channel number and depth for each channel are illustrative only and may vary depending on hardware constraints.

In some examples, the training method may include programming the first N layers of the AI chip to generate time-spectral information at 226, similar to the process 206. For example, programming may include feeding programming instructions to the AI chip to cause a microprocessor of the AI chip to operate. Programming may also include sending command instructions to the AI chip from a controller (e.g., an external device, such as a mobile or desktop device) to cause the AI chip to operate. In some examples, similar to the process 206, raw sample training voice data may be received at a first layer of the CNN and propagated through the N layers of the CNN to generate the time-spectral information. The number N may be any suitable number or identical to the number N in process 206. This step eliminates the need to preprocess audio data to generate a time-spectral diagram, e.g., a spectrogram, before being loaded into an AI chip, thus will result in faster computation utilizing the hardware of the AI chip.

With further reference to FIG. 2, the training process may further include: using the training time-spectral information to train one or more weights of the CNN at 228 and loading the one or more trained weights at 230 into the embedded CeNN of the AI integrated circuit. The trained weights will be used by block 214 in generating the voice recognition result. In training the one or more weights of the CNN, the encoding method may include: for each set of sample training voice data, receiving an indication of a class to which the sample training voice data belong. The type of classes and the number of classes depend on the AI recognition task. For example, a voice recognition task designed to recognize whether a voice is from a male or female speaker may include a binary classifier that assigns any input data into a class of male or female speaker. Correspondingly, the training process may include receiving an indication for each training sample of whether the sample is from a male or female speaker. A voice recognition task may also be designed to verify speaker identity based on the speaker's voice, as can be used in security applications.

In another non-limiting example, a voice recognition task may be designed to recognize the content of the voice input, for example, a syllable, a word, a phrase or a sentence. In each of these cases, the CNN may include a multi-class classifier that assigns each segment of input voice data into one of the multiple classes. Correspondingly, the training process also uses the same CNN structure and multi-class classifier, for which the training process receives an indication for each training sample of one of the multiple classes to which the sample belongs.

Alternatively, and/or additionally, in some scenarios, a voice recognition task may include feature extraction, in which the voice recognition result may include, for example, a vector that may be invariant to a given class of samples, e.g., a given person's utterance regardless of the exact word spoken. In a CNN, both training and recognition may use a similar approach. For example, the system may use any of the fully connected layers in the CNN, after the convolution layers and before the softmax layers. In a non-limiting example, let the CNN have six convolution layers followed by four fully connected layers. In some scenarios, the last fully connected layer may be a softmax layer in which the system stores the classification results, and the system may use the second to last fully connected layer to store the feature vector. There may be various configurations depending on the size of the feature vector. A large feature vector may result in large capacity and high accuracy for classification tasks, whereas a feature vector too large may reduce efficiencies in performing the voice recognition tasks.

The system may use other techniques to train the feature vectors directly without using the softmax layer. Such techniques may include the Siamese network, and methods used in dimension reduction techniques, such as t-Distributed Stochastic Neighbor Embedding (t-SNE), etc.

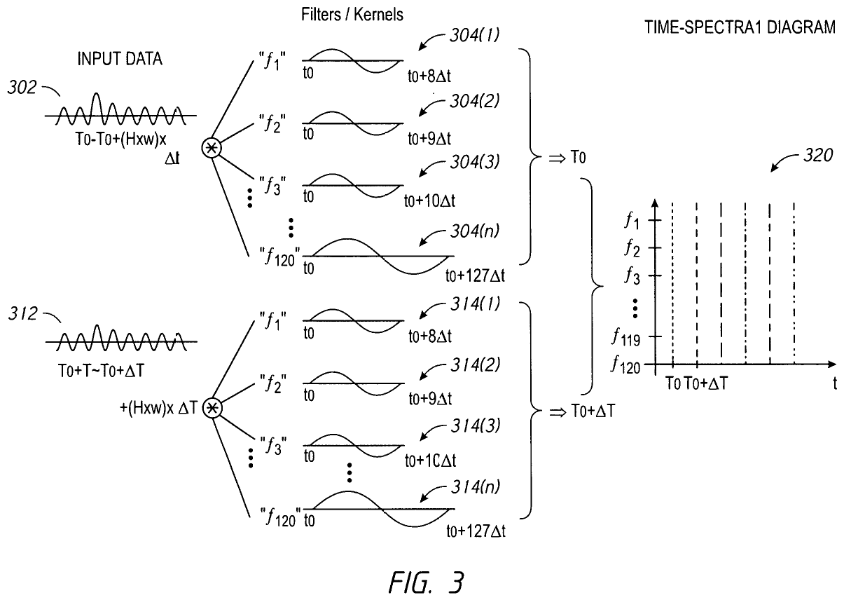

FIG. 3 illustrates an example of a process of using multiple filters in generating a time-spectral diagram of the input voice data or sample training voice data in accordance with various examples described herein. The process in FIG. 3 may be implemented in blocks 202, 204, 206, 222, 224, and/or 226. In some examples, in a CNN, each layer of the CNN has a filter/kernel to hold a respective filter, such as “f1,” “f2,” “f3,” . . . “f120” or any suitable number of filters. In the example in FIG. 3, each filter may represent one of a wavelet filter banks, e.g., 304(1), 304(2), . . . , 304(n). For example, n may be 120, or other suitable numbers. Each bank may be at a different scale. For example, filter “f1” may contain a filter bank 304(1) that contains 9 sample data from time t0 to t0+8dt, where dt is the time between two adjacent samples in the voice data. For example, if the voice input data has a single channel with a sampling rate of 16K, then each data point in the voice data is separated by dt= 1/16K=62.5 μs. In some examples, dt may be independent from the sampling rate. In some examples, filter bank 304(2) may contains 10 sample data from time t0 to t0+9dt; filter bank 304(3) may contain data from t0 to t0+10dt, and so on until filter “fn” (e.g., “f120”), which contains t0 to t0+127dt data points.

In some examples, input data 302 may be received at the first layer of the CNN. For example, input data may include the raw audio waveform and contains a number of audio data. For example, the input data may include a segment audio data from time T0 to T0+(H×W)×ΔT, where H and W are the height and width of each layer in the CNN. For example, H and W each may have a value of 224. Time difference AT may be the time difference between adjacent data points in the input data. For example, AT may be the inverse of the sampling rate of the raw audio waveform. ΔT may be different from the inverse of the sampling rate of the raw audio waveform.

In some examples, input data may be convolved with a respective filter/kernel in each layer, and the convolution result is fed into the next layer. For example, in layer 1, X₁=X₀*w₁+b₁, where X₀ is the input data, w₁ is the first filter/kernel, X₁ is the output for layer 1, b₁ is the bias term for layer 1. The operation “*” is the convolution. In layer 2, X₂=X₁*w₂+b₂, . . . in layer N, X_{N}=X_{N-1}*w_{N}+b_{N}. Applying these operations to the input data at 302 with filter banks “f1, . . . , fn,” the output for each layer may correspond to the frequency axis fat time T0. Similarly, input data at 312 that includes a segment audio data from time T0+ΔT to T0+ΔT+(H×W)×ΔT may be received at the first layer of the CNN and convolved to the wavelet filter banks “f1, f2, . . . , fn” in each layer to generate the result that corresponds to the time-spectral diagram at 320 at time T0+ΔT. Here, in the example in FIG. 3, the number of filters in the CNN is n=120. It is appreciated that n can be any suitable number.

The processes described herein facilitate the use of raw audio data in performing training and recognition tasks. The acoustic sound waves (e.g., raw data) in general have certain properties that exist in certain time ranges/windows. The use of wavelets windows, e.g., f1, f2, . . . , fn in FIG. 3, may help to identify those properties. As long as raw data in the C×H×W grid is arranged in a similar manner in which data in a convolution kernel is arranged, the data “seen” by the kernel will be on the same grid in time, except shifted by different “dt” for different input locations (H,W). Consequently, the kernels can then be “trained” to learn those time-shift invariant properties on the time grid (defined by how data is placed on the C×H×W grid). In some examples, in the time-spectral diagram, such as 320 in FIG. 3, the time-invariant properties are reflected in the amplitude of certain frequencies that are characteristic to particular sound “features.”

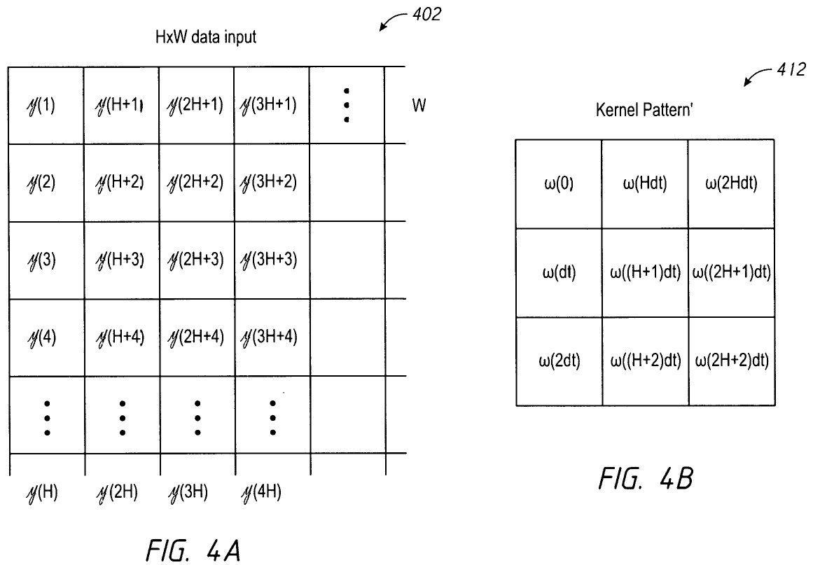

With further reference to FIG. 3, in loading the input data, e.g., at 302, 312, various methods may be implemented in block 202, 204, 222 and/or 224 in FIG. 2. In some examples, raw input data may be arranged on a C×H×W grid (where C stands for channel, H and W stand for the height and weight of the input array, respectively), so that the convolution results will include the wavelet transformation of the raw audio data, such as the time-spectral diagram 320 shown in FIG. 3. Diagram 320 may also be referred to feature maps of the input signals. Various methods of arranging the raw input data on the C×H×W grid may further be described with reference to FIGS. 4-10.

FIGS. 4A & 4B illustrate an example of data encoding and kernel pattern for implementing an audio recognition task in an AI chip in accordance with some examples described herein. In FIG. 4A, in a non-limiting example, raw input data may have a single channel with a sampling rate of 16K, thus each data point is separated by dt= 1/16K=62.5us. The input of each layer of the CNN may have a size of 224×224. The input data y(t) (e.g., the amplitude of audio voice at time t) may be arranged in either column-first (H) or row-first (W) fashion. For example, as shown in FIG. 4A, in column-first arrangement, the input data is filled with the first column of the input first, e.g., pixels y(1) to y(H), followed by the second column y(H+1) to y(2H+1), etc. As such, data contained in each column spans over H×dt=14 ms, when H=224 and dt=62.5 us. In FIG. 4B, in a non-limiting example, a corresponding filter/kernel may include a 3 by 3 stencil/array. For example, when input data is arranged in a column-first fashion, the filter/kernel ω(t) (e.g., the amplitude of the filter bank at time t) may include ω(0), ω(dt) and ω(2dt) in the first column; ω(Hdt), ω(Hdt+dt) and ω(Hdt+2dt) in the second column; and ω(2Hdt), ω(2Hdt+dt) and ω(2Hdt+2dt) in the third column. The 3×3 stencil is moved within the input array (e.g., H×W) and convoluted with the input data. For example, at column i and row k, the input data convoluted with a 3×3 filter include: y(iH+k), y(iH+k+1), y(iH+k+2), y((i+1)H+k)), y((i+1)H+k+1), y((i+1)H+k+2), y((i+2)H+k), y((i+2)H+k+1) and y((i+2)H+k+2).

In some examples, when keeping the kernel pattern fixed in time, a learning algorithm will discover the “wavelet filter banks” through the training of the neural network. For example, if a CNN is trained to detect speakers, the “words” or “contents” may not be relevant in discovering speaker identity, however, a feature (finger print) of the spectrogram might. In other words, a feature in a time-spectral diagram, such as diagram 320 in FIG. 3, or raw data spectral information obtained from the kernel pattern, may be distinguishable among various speakers and thus can be used for speaker identification. Other features may be found in the time-spectral diagram for various recognition tasks, such as word or phrase recognition, or speaker gender identification. Now the examples in FIGS. 4A and 4B are further explained to show an example of how block 206 or 226 in FIG. 2 is implemented.

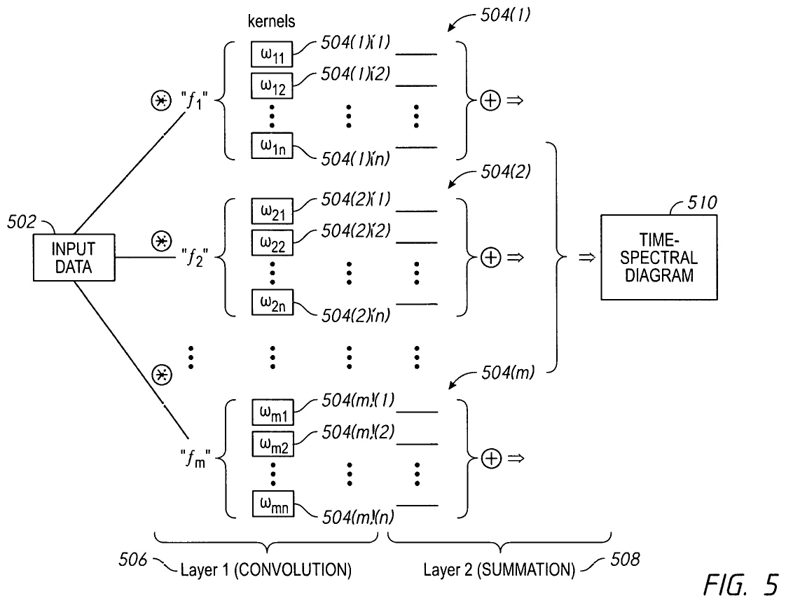

FIG. 5 illustrates an example of a process for generating a time-spectral diagram using two layers in accordance with some examples described herein. In some examples, the input of first layer of a CNN has a shape of C×H×W, where H and W are the height and width of the input array, respectively and C indicates a channel number. In this example, assume that C is l, e.g., the input layer has only one input channel, a method may use multiple kernels to represent a complete set filter banks, such as shown in 304(l), . . . , 304(n) in FIG. 3 in a time domain. In some scenarios, the method may program the CNN, such as implemented in 206 of FIG. 2, so that each of the multiple kernels may be convolved with the input data.

The set of filter banks may be “encoded” into multiple kernels in various ways. In some examples, the method may program the CNN to have multiple kernels each containing one of the filters, such as one of f1, f2, . . . fn in FIG. 3. Whereas a kernel may be limited in size, such as having a size of 3×3×1 (3×3 by 1 channel) or 3×3×3 (3×3 by 3 channels), each filter may be sub-sampled to fit into each kernel. For example, a filter having 64 sampling points may be reduced to 27 points via sub-sampling, where 27 points are fit into a 3×3×3 kernel. Similarly, a filter may also be fitted into a 3×3×1 kernel by reducing to 9 sampling points.

In some examples, the method may program the CNN to use a combination of multiple kernels to represent one filter in the set filter banks to accommodate more sampling points in each filter. For example, five kernels of a size of 3×3×1 may be used to contain 45 sampling points in a filter. In a non-limiting example, with reference to FIG. 5, multiple kernels are constructed to represent multiple filters in the set of filter banks. For example, a first set of kernels 504(1)(1), 504(1)(2), . . . 504(1)(n) represent a first filter, such as filter f1. Data in each kernel is sampled from the filter curve (e.g., 304(1) in FIG. 3) and arranged in the same manner as input data is arranged, such as column-wise fashion followed by row-wise fashion as shown in FIGS. 4A and 4B. With further reference to FIG. 5, a second set of kernels are constructed to represent a second filter, such as filter f2. Similar to the first set of kernels, data in each of the second set of kernels is sampled from the respective filter curve (e.g., 304(2) in FIG. 3) and arranged in the same manner as input data is arranged, such as column-wise fashion followed by row-wise fashion as shown in FIGS. 4A and 4B. Similarly, each of the remaining filters in the set of filter bank may be represented by a set of kernels, such as 504(m)(1), 504(m)(2), . . . 504(m)(n). Although each set of kernels, as shown in FIG. 5, includes n kernels, the value n is illustrative as a variable number. In other words, each filter may be represented by any suitable number of kernels.

With further reference to FIG. 5, the multiple kernels (e.g., 504(m)(n)) may be convolved with input data 502 in the first layer at 506. The convolution result for each kernel may be stored in the CNN and used for the next layer. For example, the convolution of kernel set 504(1)(1, . . . n) (representing a first filter f1) with the input data may produce an output 504(1), the convolution of kernel set 504(2)(1, . . . n) (representing a second filter f2) with the input data may produce an output 504(2), etc. The convolution output of each filter, e.g., 504(1), 504(2), . . . 504(m) may be stored in the CNN. For example, the output of the first layer in the CNN may include multiple channels, each may be configured to contain the convolution output for each of a kernel set representing a filter. In a non-limiting example, the first filter f1 may be represented by 5 kernels, and the convolution result of each of the five kernels with the input data may be stored in each respective channel in the output of the first layer.

With further reference to FIG. 5, the convolution output of multiple kernels with input data may be added together in a succeeding layer, e.g., the second layer of the CNN 588. In such configuration, the convolution result for each of the set of kernels, where the set represents each filter, may be added to produce the convolution result for each filter. These added results may fill in data for the time-spectral diagram 510 (e.g., 320 in FIG. 3). In other words, the convolution result for each of the multiple kernels may be contained in a respective output channel of a first layer of the CNN at 506. As such, multiple output channels in the first layer may represent the complete filter banks defined in the time domain. Each kernel may be only a subset of the sampled filter values for a given filter, but when added together (e.g., in the second layer at 508), a complete wavelet transformation may be constructed.

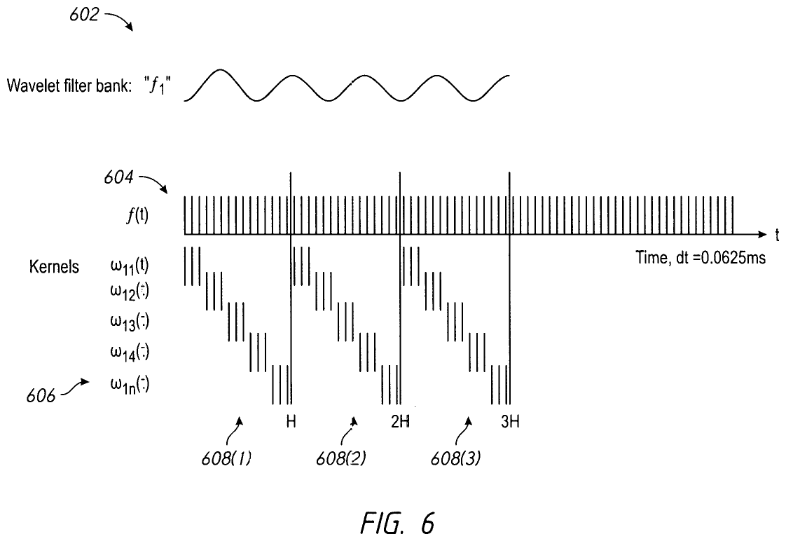

FIG. 6 illustrates an example of kernel pattern and data alignment for implementing a convolution in audio recognition task in an AI chip in accordance with some examples described herein, such as examples in FIGS. 4A, 4B and 5. In FIG. 6, a filter of a set of filter banks, such as filter f1 is represented by multiple kernels 606. Each of the multiple kernels may contain data that is arranged in the same manner as input data is arranged. For example, input data may include multiple samples from an audio waveform and the samples are arranged in a column-wise fashion, such as shown in FIG. 4A. Kernel data ω(t) may include multiple samples from a given filter f(t) and the samples are arranged also in a column-wise fashion, such as shown in FIG. 4B. In a non-limiting example, FIG. 6 shows three columns on a kernel tensor, such as in 608(1), 608(2) and 608(3). Multiple kernels, such as ω₁₁(t), ω₁₂(t), ω₁₃(t), ω₁₄(t), . . . ω₁ₙ(t), may be used to represent filter f(t). In some scenarios, a first kernel, such as ω₁₁(t) may include samples from the filter, where the first column in the kernel includes the samples at time 0, dt and 2dt. The second column may include samples at time Hdt, Hdt+dt and Hdt+2dt. The third column may include samples at time 2Hdt, 2Hdt+dt, 2Hdt+2dt. The second kernel ω₁₂(t) may also include three columns, with the first column including samples at time 3dt, 4dt and 5dt, the second column including samples at time Hdt+3dt, Hdt+4dt, Hdt+5dt, and the third column including samples at 2Hdt+3dt, 2Hdt+4dt and 2Hdt+5dt. The bars in each column 608(1), 608(2) and 608(3) indicates how each data in the kernel is obtained from sampling the continuous wavelet function, e.g., the filter bank. As shown, the pixels in each column in the kernel increments by Hdt samples in the filter. This allows the kernel to be properly “aligned” with the input data in the convolution.

When each kernel is convolved with the input data y(t), in a column-wise representation, the convolution result Y=y (*) ω, where y(i, j, k) is convolved with ω(cᵢ, cⱼ, cₖ), and (*) is the convolution operator. In an element-by-element representation, Y(i, j)=sum (cᵢ, cⱼ, cₖ)(y(i+cᵢ, j+cⱼ, k+cₖ)*ω(cᵢ, cⱼ, cₖ), where sum (cᵢ, cⱼ, cₖ) is the summation of all possible sum (cᵢ, cⱼ, cₖ) values, e.g., all elements of all kernels. In performing summation, in a second layer, such as 508 in FIG. 5, certain ω(cᵢ, cⱼ, cₖ) may have values of {0, +1, −1}. Then the convolution operation becomes a selective summation operation. For example, in the second layer, the kernel values can only be assigned to {0, 1} to carry out the needed summation.

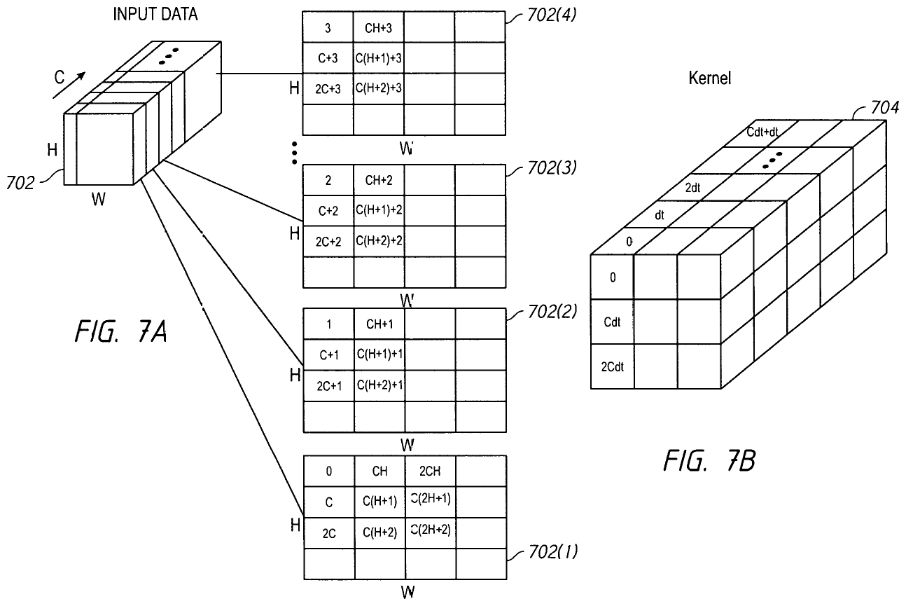

FIGS. 7A & 7B illustrate an example of data encoding and kernel pattern for implementing an audio recognition task in an AI chip in accordance with some examples described herein. In some examples, the input data of a CNN may include multiple channels and input data may be arranged in a channel-wise fashion, followed by a column-wise fashion, which is followed by a row-fashion. In such configuration, the first pixel (first column, first row) for each of the channels may include input data having an index (e.g., time dt) of 0, 1, 2, etc. The second pixel (first column, second row) for each of the channels may include data having an index of C, C+1, C+2, etc. The third pixel (first column, third row) for each of the channels may include data having an index of 2C, 2C+1, 2C+2 etc. In other words, in the first channel, the pixel index at each of the pixels in the first column increments by C. The second column starts with C×H and each pixel increments by C. The third column start with C×2H, and each pixel also increments by C. In a non-limiting example, input data 702 may have a shape of C×H×W, such as 16×112×112. The first channel 702(1) of input data 702 may include: a first column having the index values of 0, 16, 32, . . . ; a second column having the index values of 1792, 1808, 1824, . . . ; a third column having the index values of 3584, 3600, 3616, . . . etc. The second channel 702(2) of input data 702 may include: a first column having the index values of 1, 17, 33, . . . ; a second column having the index values of 1793, 1809, 1825, . . . ; a third column having the index values of 3585, 3601, 3617, . . . etc.

With reference to FIG. 7B, data in the kernel(s) are also arranged in a similar manner as data in FIG. 7A. For example, a kernel 704 may have multiple channels and include data sampled from a given wavelet filter, where the data are arranged also in a channel-wise fashion, followed by a column-wise fashion, which is followed by a row-wise fashion. In the example in FIG. 7B, in the first channel, the first pixel (first column, first row) for each of the channels may include filter data having an index (e.g., time) of 0, dt, 2dt, etc. The second pixel (first column, second row) for each of the channels may include data having an index of Cdt, Cdt+1, Cdt+2, etc. The third pixel (first column, third row) for each of the channels may include data having an index of 2Cdt, 2Cdt+1, 2Cdt+2 etc. In other words, in the first channel, the pixel index at each of the pixels in each column increments by Cdt.

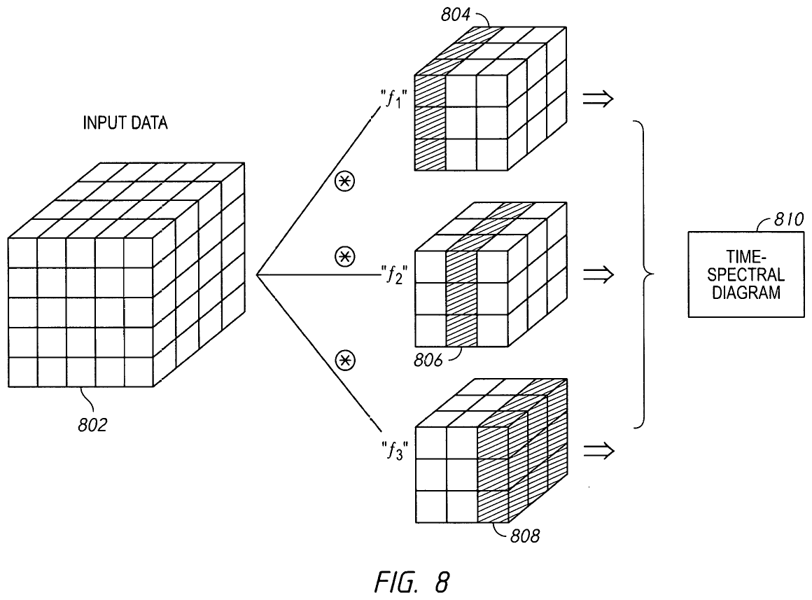

FIG. 8 illustrates an example of a process for generating a time-spectral diagram in accordance with some examples described herein, such as examples in FIGS. 7A and 7B. As shown in FIG. 7B, each column of kernel is associated with a continuous block of data in the filter, for example, 16×3=48 samples for a kernel having a channel of 16. Returning to FIG. 8, each column, such as 804, 806, 808, may each represent a respective filter, such as f1, f2, f3, and each may convolve with the input data 802 to generate a time-spectral diagram 810. In some examples, when performing a convolution of a kernel to input data, a kernel applied to different locations on the input data (e.g., having C channels) will correspond to a time shifted version of those three continuous blocks in the kernel.

In some examples, arranging continuous block of data in a kernel may treat the blocks of continuous data, such as three blocks, as three independent (uncorrelated) samples. In outputting the convolution result, the three blocks of data may each include an identical filter and share the same weight. The resulted convolution may be treated as the average of three identical filters.

Alternatively, each kernel may use more than one or all of the columns to represent a single filter. For example, a kernel may include three blocks of continuous data (in three columns) as related samples, or a subset of a large sample. A wavelet filter may be represented across multiple blocks of continuous data, such as multiple columns of a kernel as shown in FIG. 8. In a non-limiting example, for example, the kernel has a size of C×3×3, the 3 columns of the kernel may contain 3 subsets of a much larger filter. The convolution results for the three subsets may be recombined at a second layer to generate the convolution result for one wavelet filter, in a similar fashion as shown in FIG. 5.

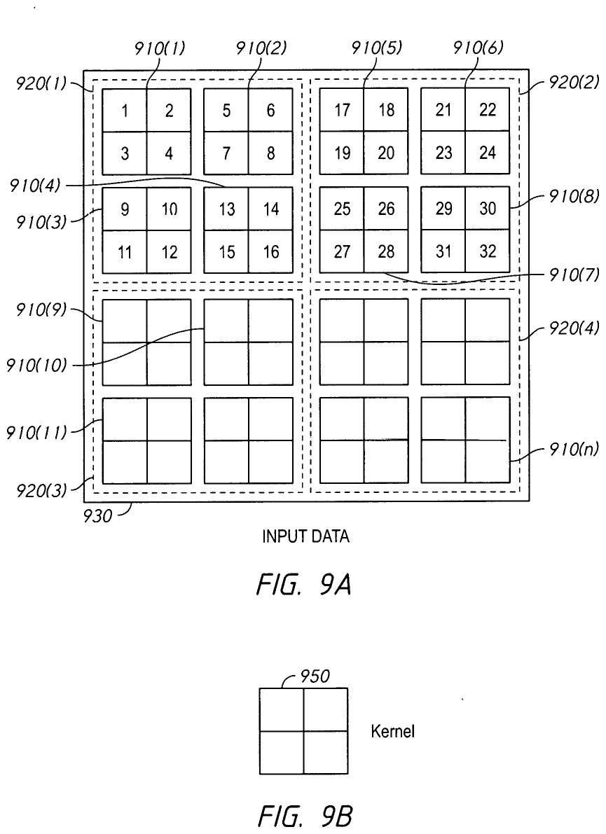

FIGS. 9A & 9B illustrate an example of data encoding and kernel pattern for implementing an audio recognition task in an AI chip in accordance with some examples described herein. In some examples, input data may be arranged in a recursive multi-resolution fashion. In a non-limiting example, the number of channels is one, the size of the input data array is 112×112. Input data may be arranged, first in a 2×2 block. For example, the encoding method may fill the input data in a 2×2 block, such as block 910(1), where data may be arranged by row-column fashion. The encoding method may arrange the second block, e.g., 910(2) in a larger block, such as 920(1) having a size of 4×4. The larger block contains multiple blocks having the smaller size. For example, block 920(1) has four smaller blocks 910(1), 910(2), 910(3) and 910(4). The encoding method may arrange these smaller blocks in the larger block also in the row-column fashion. In the example in FIG. 9A, after filling in block 910(1), the encoding method fills the next block 910(2), then fills block 910(3) followed by 910(4), in the same row-column fashion as in block 910(1), to complete the first larger block 920(1).

With further reference to FIG. 9A, once the larger block, e.g., 920(1) is filled, the encoding method fills the next larger block, e.g., 920(2), 920(3) and 920(4) in a row-column order, where blocks 920(1), 920(2), 920(3) and 920(4) fills up the next larger block 930 having a size of 8×8. Although data are shown to be arranged in a W×H fashion, multiple channels can also be used. For example, data may be arranged in C×W×H, such as channel first, followed by row and column, similar to the manner shown in FIG. 7A. In FIG. 7B, in some examples, kernel 950 may contain samples of filters, in which data may be arranged in a similar fashion as shown in FIG. 7B. In the example in FIG. 9A, convolution may be carried with a C×3×3 kernel with a stride of 2 in column and 2 in row direction. Each data point in the input tensor is used exactly once, where data is arranged sequentially in the order in which convolution is carried out.

In arranging the data in a multi-resolution fashion, proper sub-sampling (e.g., regularly skip certain fixed number of samples, such as taking one out of every 4 samples) may be used. Using multi-resolution encoding, data within each larger block, such as 920(1) having C×4×4 samples, may span a period of time in the raw audio data and capture several audio segments in different time scales. Thus, different data samples in different blocks at the same resolution level, such as 920(1), 920(2), 920(3), 920(4), should share the same time-invariant properties, i.e. share the same filters. In such configuration, only one convolution layer may be used to capture voice features at several time scales within a short time window. The resulted “feature maps” (e.g., outputs of the convolution) may be an overlapped, sequential inputs for sub-sequent layers.

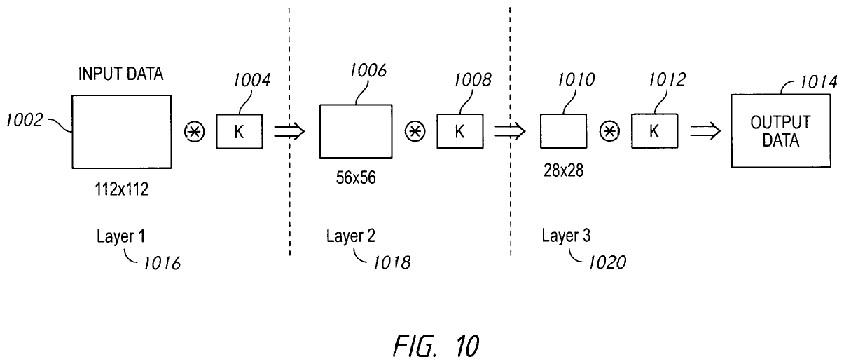

FIG. 10 illustrates an example of a process for generating a time-spectral diagram in accordance with some examples described herein, such as descriptions in FIGS. 9A and 9B. In some examples, the convolution may be performed using multiple layers in the CNN. For example, input data 1002 may first be convolved with kernel 1004 in a first layer 1016, in which a kernel may have a size of C×2×2. The voice data in the input data 1002 may be arranged in a similar fashion as described in FIG. 9A. The CNN may be programmed to produce an output having a reduced resolution. For example, the input data 1002 may have a resolution of 112×112, and the output may have a resolution of 56×56, in which each pixel in the output may be based on a combination of the result of four pixels, such as four pixels in block 910(1). The output from the first layer may be fed to the second layer.

With further reference to FIG. 10, the CNN may be programmed to have a second layer 1018 to include the input data 1006 from the output of the first layer. In this example, the input data 1006 has a reduced resolution, such as having a resolution of 56×56. The CNN may further be programmed to perform a convolution of kernel 1008 with the input data 1006 and produce a result having a further reduced resolution. For example, the input data 1006 may have a resolution of 56×56 in which each pixel represents a 2×2 block in the raw data, such as blocks 910(1), 910(2), . . . etc. The output may have a resolution of 28×28, in which each pixel in the output may be based on a combination of the result of four pixels in the input, such as four blocks in block 920(1). The output from the second layer may be fed to the third layer.

With further reference to FIG. 10, the CNN may be programmed to have a third layer 1020 to include the input data 1010 from the output of the second layer. In this example, the input data 1010 has a reduced resolution, such as having a resolution of 28×28. The CNN may further be programmed to perform a convolution of kernel 1012 with the input data 1010 in the third layer and produce an output data 1014. For example, the input data 1010 may have a resolution of 28×28 in which each pixel represents a 4×4 block in the raw data, such as blocks 920(1), 920(2), . . . etc. In the descriptions in FIGS. 9A, 9B and 10, convolutions at multiple resolutions may be achieved while performing skipping in the input raw data (as can be configured in a CNN) without having to change the size of convolution kernels.

In obtaining the coefficients for kernels in various layers in the CNN, in some examples, a linear combination can be used. For example, let data in the second layer L2(X′) be expressed in terms of data in the first layer, e.g., L2(X′)=sum(L1(X)*K1), where K1 is the kernel in the first layer, L1(X) is data in the first layer, and “*” is the convolution operator. Similarly, data in the third layer L3(X″) may be expressed as L3(X″)=sum(L2(X′)*K2)=sum(sum(L1(X)*K1)*K2), where K2 is the kernel in the second layer. If each of the above formula is carried out at each layer and data in the third layer L3(X″) is expressed in a linear combination of data in the first layer L1(X), then kernel coefficients may be obtained such that data in the third layer is a valid filtered value of input data.

Additionally and/or alternatively, each of the filter banks may be learned via a training of the CNN. For example, given training targets, such as lower cost of cross entropy or softmax values, etc., a training algorithm may be used to discover filter values, which may be expressed in several layers. In achieving this, “feature” is relative to the range of data seen at each layer in a hierarchical (layered) network. In other words, “features” at the lower layers can be expressed by “features” of the upper layers.

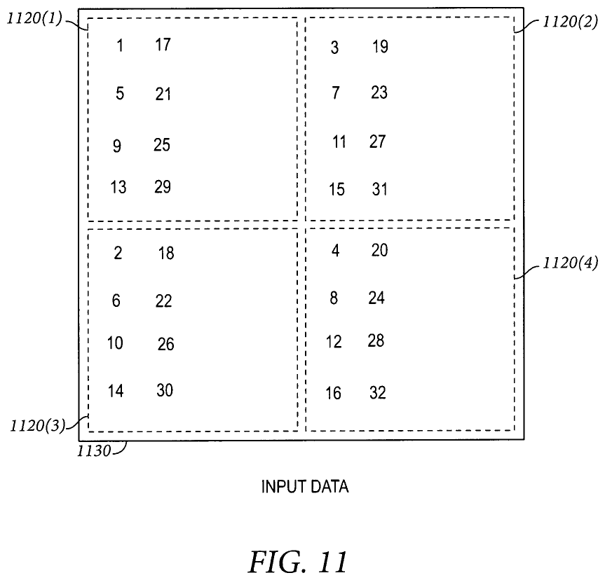

It is appreciated that data arrangement may vary in achieving multi-resolution convolution. For example, in each channel, input data may be arranged in a column-wise first followed by row-wise fashion. Further, FIG. 11 illustrates an example of data encoding for implementing an audio recognition task in an AI chip in accordance with some examples described herein. In encoding data in a multi-resolution fashion, instead of filling in each small block, data may be arranged more evenly across multiple larger blocks. For example, input data may be filled sequentially in a same location in each of a block arranged in a larger block. In FIG. 11, in a non-limiting example, the encoding method may fill in the four blocks 1120(1), 1120(2), 1120(3) and 1120(4) in a larger block 1130 evenly. Each of the blocks 1120(1), 1120(2), 1120(3) and 1120(4) may be arranged in a column-row fashion, and data may be filled up one at a time in each block. For example, the encoding method may fill up the first data in block 1120(1), then fill up the first data in block 1120(3), 1120(2) and 1120(4) sequentially. The encoding method fills the next data in block 1120(1) also in the same fashion, such as column-row, then the next data in block 1120(3), 1120(2) and 1120(4) sequentially.

Multi-resolution encoding may allow each layer of the CNN to “see” different resolution. For example, a CNN includes 3 layers, each including a kernel of a size of 2×2. As such, a data point “x” in layer 2 may be affected by a 2×2 data block in layer 1, which may be subsequently affected by a 2×2 data block in layer 0. If a stride of two is used to avoid data reuse in convolution, the regions seen by different layers have different “resolution” on the input image. Although kernels at different layers may all be 2×2 or 3×3, but the “data” they see are different at different layers. In layer 1, “features” on the smallest time scale may be seen, whereas the same “features” in layer 1 may be “seen” on a larger time scale in layer 2. Those “features” may be the trained as kernel parameters on each layer in a training process, such as described in FIG. 2. Even methods are described to assign filter values to the kernels, optionally or alternatively, the encoding method may include training or fine tuning the kernel parameters in the training process, such as described in FIG. 2.

In various embodiments in FIGS. 1-10, variations may be possible. For example, the convolution of input data with kernel may allow overlapping between successive convolutions. Optionally, the encoding method may use a 1×1 kernel, instead 2×2 or 3×3. The use of 1×1 kernel may avoid mixing data from different time windows, resulting in a “clean” time-spectral diagram. Optionally, the encoding method may include duplicating input data from a previous block to avoid losing/skipping raw data in the time domain. For example, when input data is arranged in the channel-column-row fashion, at the end of each column, the pixel in the last row may be duplicated from a preceding row in the same column. In a non-limiting example, a pixel at input data at (H, W) may be duplicated from the pixel value at input data at (H, W−1). Alternatively, zero padding may also be used.

In some examples, the encoding method use regular skipping (i.e., skipping certain number of samples, as sub-sampling) on the input data or filter values. As a result, different sampling rate on channel, column or row may be achieved, which may facilitate capturing of frequency properties of the input data within a convolution kernel operation.

The above illustrated embodiments in FIGS. 1-11 provide advantages in encoding audio data to be loaded into an AI chip without preprocessing, facilitating the AI chip to use the raw audio data to generate time-spectral information to be used for subsequent AI recognition tasks. This would allow an AI system, e.g., a mobile device having an AI chip, to be running AI tasks more efficiently in the AI chip, thus save power for the device.

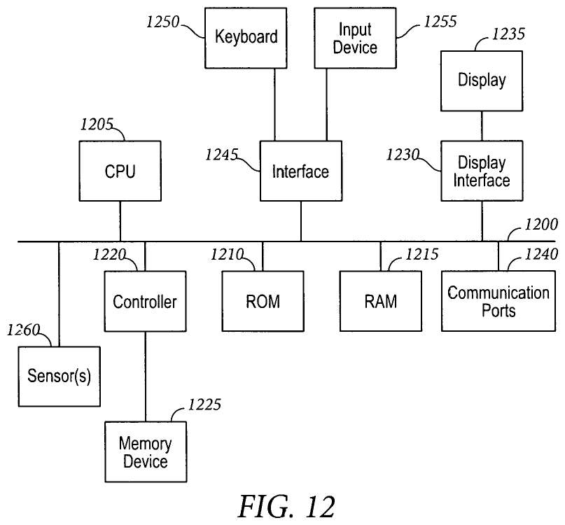

FIG. 12 depicts an example of internal hardware that may be included in any electronic device or computing system for implementing various methods in the embodiments described in FIGS. 1-11. An electrical bus 1200 serves as an information highway interconnecting the other illustrated components of the hardware. Processor 1205 is a central processing device of the system, configured to perform calculations and logic operations required to execute programming instructions. As used in this document and in the claims, the terms “processor” and “processing device” may refer to a single processor or any number of processors in a set of processors that collectively perform a process, whether a central processing unit (CPU) or a graphics processing unit (GPU) or a combination of the two. Read only memory (ROM), random access memory (RAM), flash memory, hard drives and other devices capable of storing electronic data constitute examples of memory devices 1225. A memory device, also referred to as a computer-readable medium, may include a single device or a collection of devices onto which data and/or instructions are stored.

An optional display interface 1230 may permit information from the bus 1200 to be displayed on a display device 1235 in a visual, graphic or alphanumeric format. An audio interface and an audio output (such as a speaker) also may be provided. Communications with external devices may occur using various communication devices 1240 such as a transmitter and/or receiver, antenna, an RFID tag and/or short-range or near-field communication circuitry. A communication device 1240 may be attached to a communications network, such as the Internet, a local area network (LAN) or a cellular telephone data network.

The hardware may also include a user interface sensor 1245 that allows for receipt of data from input devices 1250 such as a keyboard, a mouse, a joystick, a touchscreen, a remote control, a pointing device, a video input device and/or an audio input device, such as a microphone. For example, input device 1250 may include a microphone configured to capture voice input data for loading into the AI chip and generating the time-spectral diagram. Digital image frames may also be received from an imaging capturing device 1255 such as a video or camera that can either be built-in or external to the system. Other environmental sensors 1260, such as a GPS system and/or a temperature sensor, may be installed on system and communicatively accessible by the processor 1205, either directly or via the communication device 1240. The communication ports 1240 may also communicate with the AI chip to upload or retrieve data to/from the chip. For example, the computer system may implement the encoding methods and upload the trained CNN weights or the encoded audio data to the AI chip via the communication port 1240. The communication port 1240 may also communicate with any other interface circuit or device that is designed for communicating with an integrated circuit.

Optionally, the hardware may not need to include a memory, but instead programming instructions are running on one or more virtual machines or one or more containers on a cloud. For example, the various methods illustrated above may be implemented by a server on a cloud that includes multiple virtual machines, each virtual machine having an operating system, a virtual disk, virtual network and applications, and the programming instructions for implementing various functions in the robotic system may be stored on one or more of those virtual machines on the cloud.

Various embodiments described above may be implemented and adapted to various applications. For example, an AI integrated circuit having a cellular neural network architecture may be residing in an electronic mobile device. The electronic mobile device may also have a voice or image capturing device, such as a microphone or a video camera for capturing input audio/video data, and use the built-in AI chip to generate recognition results. In some scenarios, training for the CNN can be done in the mobile device itself, where the mobile device captures or retrieves training data samples from a database and uses the built-in AI chip to perform the training. In other scenarios, training can be done in a service device or on a cloud. These are only examples of applications in which an AI task can be perform in the AI chip.

The above illustrated embodiments are described in the context of implementing a CNN solution in an AI chip, but can also be applied to various other applications. For example, the current solution is not limited to implementing CNN but can also be applied to other algorithms or architectures inside a chip. The voice encoding methods can still be applied when the bit-width or the number of channels in the chip varies, or when the algorithm changes.

It will be readily understood that the components of the present solution as generally described herein and illustrated in the appended figures could be arranged and designed in a wide variety of different configurations. Thus, the following more detailed description of various implementations, as represented in the figures, is not intended to limit the scope of the present disclosure, but is merely representative of various implementations. While the various aspects of the present solution are presented in drawings, the drawings are not necessarily drawn to scale unless specifically indicated.

The present solution may be embodied in other specific forms without departing from its spirit or essential characteristics. The described embodiments are to be considered in all respects only as illustrative and not restrictive. The scope of the present solution is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present solution should be or are in any single embodiment thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One ordinarily skilled in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

Other advantages can be apparent to those skilled in the art from the foregoing specification. Accordingly, it will be recognized by those skilled in the art that changes, modifications or combinations may be made to the above-described embodiments without departing from the broad inventive concepts of the invention. It should therefore be understood that the present solution is not limited to the particular embodiments described herein, but is intended to include all changes, modifications, and all combinations of various embodiments that are within the scope and spirit of the invention as defined in the claims.

We claim:

1. A method comprising:
receiving, by a processor, voice data comprising at least a segment of an audio waveform;
loading the voice data into an input array of a cellular neural network (CeNN) in an AI integrated circuit;
loading one or more filters into one or more kernels of the CeNN, wherein each of the one or more filters respectively represents a frequency; and
performing one or more operations on the voice data in the AI integrated circuit to generate a time-spectral diagram.

2. The method of claim 1 further comprising:
outputting, by the AI integrated circuit, a voice recognition result based on the time-spectral.

3. The method of claim 2, wherein:
performing the one or more operations comprises performing convolution operations on the voice data with the one or more kernels in a first layer of the CeNN in the AI integrated circuit; and
outputting the voice recognition result comprises at least performing the voice recognition in a second layer other than the first layer of the CeNN in the AI integrated circuit.

4. The method of claim 1, wherein the time-spectral diagram includes a plurality of pixels each comprising a value that represents an audio intensity of the segment of the audio waveform at a time in the segment and the frequency represented by one of the one or more filters.

5. The method of claim 1, wherein loading the one or more filters comprises loading each filter into a respective set of kernels, each set of kernels representing a corresponding filter and each kernel in the set of kernels includes at least a portion of the corresponding filter.

6. The method of claim 5, wherein performing the one or more operations comprises:
performing, in a first layer of the CeNN, a convolution of the voice data with each of the one or more kernels to generate a respective convolution output for each kernel; and
performing, in a second layer of the CeNN, summation operations to generate the time-spectral diagram based on the convolution output for the one or more kernels.

7. The method of claim 6, wherein performing the summation operations comprises combining the convolution output for each kernel in a set of kernels representing the corresponding filter to generate an entry in the time-spectral diagram for a corresponding frequency represented by the corresponding filter.

8. The method of claim 1, wherein loading the one or more filters comprises loading each filter into an associated kernel.

9. The method of claim 8, wherein, for each filter, the associated kernel includes data values of at least a portion of that filter, the data values are arranged in a continuous data block in the associated kernel.

10. The method of claim 1 further comprising:
receiving a set of sample training voice data comprising at least one sample segment of an audio waveform;
loading the set of sample training voice data into the input array of the CeNN of the AI integrated circuit;
loading the one or more filters into the one or more kernels of the AI integrated circuit;
performing one or more operations on the set of sample training voice data in the AI integrated circuit to generate a training time-spectral diagram.

11. The method of claim 10 further comprising:
using the training time-spectral diagram to train one or more weights of a convolutional neural network; and
load the one or more trained weights of the convolutional neural network into the CeNN of the AI integrated circuit.

12. A system for encoding voice data for loading into an artificial intelligence (AI) integrated circuit, the system comprising:
a processor; and
a non-transitory computer readable medium containing programming instructions that, when executed, will cause the processor to:
receive voice data comprising at least a segment of an audio waveform;
load the voice data into an input array of a cellular neural network (CeNN) in the AI integrated circuit;
load one or more filters into one or more kernels of the CeNN, wherein each of the one or more filters respectively represents a frequency; and
cause the AI integrated circuit to perform one or more operations on the voice data to generate a time-spectral diagram.

13. The system of claim 12 further comprising additional programming instructions configured to cause the processor to cause the AI integrated circuit to output a voice recognition result based on the time-spectral.

14. The system of claim 13, wherein:
programming instructions for performing the one or more operations comprise programming instructions to cause the AI integrated circuit to perform convolution operations on the voice data with the one or more kernels in a first layer of the CeNN in the AI integrated circuit; and
programming instructions for outputting the voice recognition result comprise programming instructions configured to cause the AI integrated circuit to at least perform the voice recognition in a second layer other than the first layer of the CeNN in the AI integrated circuit.

15. The system of claim 12, wherein the time-spectral diagram includes a plurality of pixels each comprising a value that represents an audio intensity of the segment of the audio waveform at a time in the segment and the frequency represented by one of the one or more filters.

16. The system of claim 12, wherein programming instructions for loading the one or more filters comprise programming instructions configured to load each filter into a respective set of kernels, each set of kernels representing a corresponding filter and each kernel in the set of kernels includes at least a portion of the corresponding filter.

17. The system of claim 16, wherein programming instructions for performing the one or more operations comprise programming instructions configured to cause the AI integrated circuit to:
perform, in a first layer of the CeNN, a convolution of the voice data with each of the one or more kernels to generate a respective convolution output for each kernel; and
perform, in a second layer of the CeNN, summation operations to generate the time-spectral diagram based on the convolution output for the one or more kernels.

18. The system of claim 17, wherein programming instructions for performing the summation operations comprise programming instructions configured to combine the convolution output for each kernel in a set of kernels representing the corresponding filter to generate an entry in the time-spectral diagram for a corresponding frequency represented by the corresponding filter.

19. The system of claim 12, wherein programming instructions for loading the one or more filters comprise programming instructions configured to load each filter into an associated kernel.

20. The system of claim 19, wherein, for each filter, the associated kernel includes data values of at least a portion of that filter, the data values are arranged in a continuous data block in the associated kernel.

21. The system of claim 12 further comprising additional programming instructions configured to cause the processor to:
receive a set of sample training voice data comprising at least one sample segment of an audio waveform;
load the set of sample training voice data into the input array of the CeNN of the AI integrated circuit;
load the one or more filters into the one or more kernels of the AI integrated circuit;
cause the AI integrated circuit to perform one or more operations on the set of sample training voice data to generate a training time-spectral diagram.

22. The system of claim 21 further comprising additional programming instructions configured to cause the processor to:
use the training time-spectral diagram to train one or more weights of a convolutional neural network; and
load the one or more trained weights of the convolutional neural network into the CeNN of the AI integrated circuit.
